(19) United States
(12) Patent Application Publication
(10) Pub. No.: US 2007/0223032 A1
(43) Pub. Date: Sep. 27, 2007

(54) Printer, Method, Computer-Readable Medium, And Computer Data Signal

(75) Inventor: Takashi Hashizume, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/561,450

(22) Filed: Nov. 20, 2006

(30) Foreign Application Priority Data
Mar. 27, 2006 (JP) 2006-084726

(51) Int. Cl. G06F 3/12

(52) U.S. Cl. 358/1.15

(57) ABSTRACT

A printer includes an instruction book specification unit that accepts a specification of an instruction book in which print instructions are described; a document specification unit that accepts a specification of a document to be printed; and a print processing unit that prints the specified document in accordance with the print instructions described in the specified instruction book.

### PRIORITY INFORMATION

This application claims priority from Japanese Patent Application No. 2006-84726, filed on Mar. 27, 2006.

### BACKGROUND

1. Technical Field

The present invention relates to a printer, a method, a computer-readable medium, and a computer data signal.

2. Related Art

When the user copies data on an MFP (Multi Function Peripheral) that has a copy function and a printer function, the user specifies print settings on the operation panel of the MFP. When the user prints data, the user specifies print settings on the screen of a computer from which print data are sent.

### SUMMARY

According to one aspect of the present invention, there is provided a printer having: an instruction book specification unit that accepts a specification of an instruction book in which print instructions are described; a document specification unit that accepts a specification of a document to be printed; and a print processing unit that prints the specified document in accordance with the print instructions described in the specified instruction book.

### BRIEF DESCRIPTION OF THE DRAWINGS

Exemplary embodiments of the present invention will be described in detail based on the following figures, wherein:

FIG. 1 is a block diagram showing the configuration of a system including a printer in this embodiment;

FIG. 2 is a flowchart showing a procedure for document print processing;

FIG. 3 is a flowchart showing a procedure for instruction book creation processing; and

FIG. 4 is a flowchart showing a procedure for instruction book editing processing.

### DETAILED DESCRIPTION

An exemplary embodiment of the present invention will be described below with reference to the drawings.

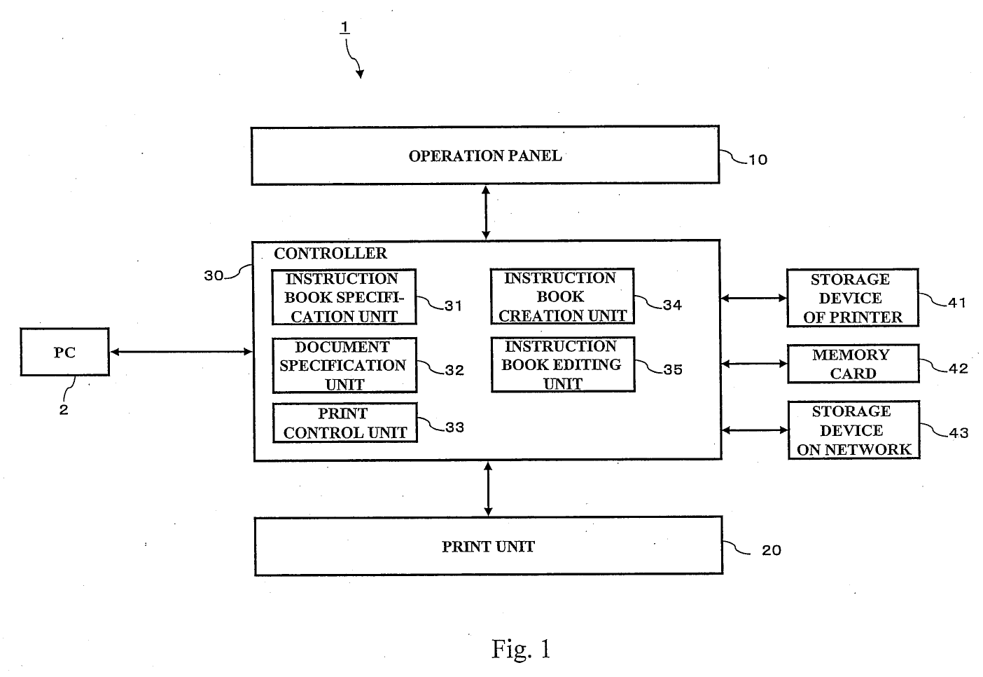

FIG. 1 is a block diagram showing the configuration of a system including a printer 1 in this embodiment. The printer 1, which is a device for printing electronic documents (hereinafter simply called “documents”), is an MFP in this exemplary embodiment that has a printer function, a scanner function, and a copy function. As shown in FIG. 1, the printer 1 includes an operation panel 10, a print unit 20, and a controller 30.

The operation panel 10 is, for example, a touch-panel display, and is a user interface that presents various types of information to the user and accepts an operation input from the user.

The print unit 20 is a device that prints images on a print medium, such as paper, by means of an appropriate print method such as the xerography method or the inkjet method.

The controller 30 controls the printer 1 in its entirety. In this exemplary embodiment, the controller 30 is a circuit board on which a CPU (Central Processing Unit), ROM (Read Only Memory), a memory, and NVRAM (Non Volatile RAM) are installed. The function of the controller 30 is implemented by the CPU executing a program read from a recording medium such as the ROM. The controller 30 includes the following functional blocks: an instruction book specification unit 31, a document specification unit 32, a print control unit 33, an instruction book creation unit 34, and an instruction book editing unit 35.

The instruction book specification unit 31 accepts the specification of an instruction book (also called a job ticket) in which print instructions are described. In this exemplary embodiment, the instruction book specification unit 31 accepts the specification of an instruction book file, in which print settings are described in a predetermined description format such as XML (Extensible Markup Language), from the user via the operation panel 10. Well-known print settings include double-sided printing, N-up print printing, stapling, punching, color printing, and sorting/stacking. The instruction book specification unit 31 can accept the specification of an instruction book stored in a storage device 41 of the printer, an instruction book stored on a memory card 42, which is a portable storage device, and an instruction book stored in a storage device 43 on a network. The instruction book specification unit 31 can also accept the specification of an instruction book created by the printer 1 and an instruction book created by other devices. In this case, examples of other devices include a personal computer (PC).

The document specification unit 32 accepts the specification of a document to be printed. In this exemplary embodiment, the document specification unit 32 accepts the specification of a document file from the user via the operation panel 10. The document specification unit 32 can also accept the specification of a document stored in the storage device 41 of the printer, a document stored on the memory card 42, and a document stored in the storage device 43 on the network.

The print control unit 33 works with the print unit 20 to print a document, specified by the document specification unit 32, in accordance with the print instructions described in an instruction book specified by the instruction book specification unit 31. That is, the print control unit 33 causes the print unit 20 to print the document in accordance with the print settings described in the instruction book.

The instruction book creation unit 34 accepts a user operation via the operation panel 10, creates an instruction book by reference to the user operation, and stores the created instruction book in a storage device. In this exemplary embodiment, the instruction book creation unit 34 accepts the specification of a storage device from the user via the operation panel 10 and stores the instruction book in the specified storage device. As the storage device, the user can specify the storage device 41 of the printer, the memory card 42, or the storage device 43 on the network.

The instruction book editing unit 35 accepts a user operation via the operation panel 10 and, by reference to the user operation, edits an instruction book prepared in advance. The instruction book prepared in advance is an instruction book created by the printer 1 or other devices and stored in the storage device 41 of the printer, the memory card 42, or the storage device 43 on the network.

The following describes the operation of the printer 1 having the configuration described above. In the below description, the operation is further divided into document print processing, instruction book creation processing, and instruction book editing processing.

(Document Print Processing)

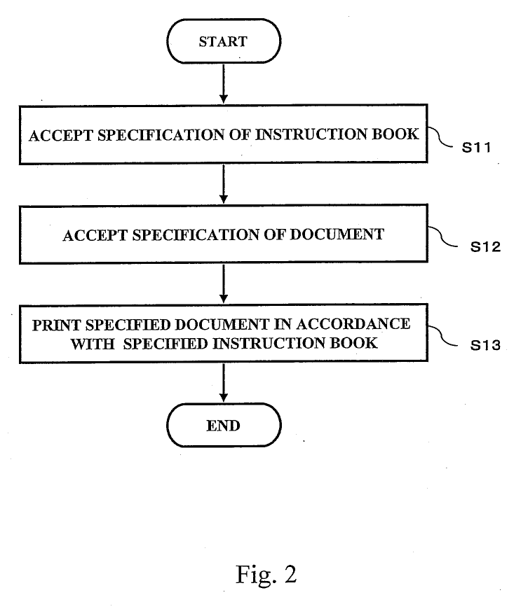

FIG. 2 is a flowchart showing the procedure for the document print processing. This document print processing is executed, for example, when a “Print Document” button is pressed on the screen of the operation panel 10.

As shown in FIG. 2, the instruction book specification unit 31 accepts the specification of an instruction book from the user via the operation panel 10 (S11). In this case, the user can select an instruction book file stored in one of the storage device 41 of the printer, the memory card 42, and the storage device 43 on the network. The below description is based on the assumption that the user stores the instruction book on the memory card 42 in advance, inserts the memory card 42 into a memory card slot (not shown) of the printer 1, and specifies the instruction book stored on that memory card.

The document specification unit 32 accepts the specification of a document from the user via the operation panel 10 (S12). In this case, the user can select a document file stored in one of the storage device 41 of the printer, the memory card 42, and the storage device 43 on the network. The below description is based on the assumption that the user stores the document on the memory card 42 in advance, inserts the memory card 42 into the memory card slot of the printer 1, and specifies the document stored on that memory card.

The print control unit 33 works with the print unit 20 to print the specified document by reference to the description in the specified instruction book (S13). More specifically, the print control unit 33 reads the instruction book specified in step S11, as well as the document specified instep S12, from the memory card 42 inserted into the memory card slot. The print control unit 33 controls the print unit 20 to print the document, which is read, in accordance with the print settings described in the instruction book which is read. For example, if the instruction book describes that “the front colored cover sheet is applied, the document is double-side printed with the long edge bound, the document is punched on the left side, and the document is stapled in the upper-left corner,” the print unit 20 applies the front colored cover sheet, prints the document on both sides with the long edge bound, punches the document on the left, and staples the document in the upper-left corner, in accordance with the control instruction from the print control unit 33.

(Instruction Book Creation Processing)

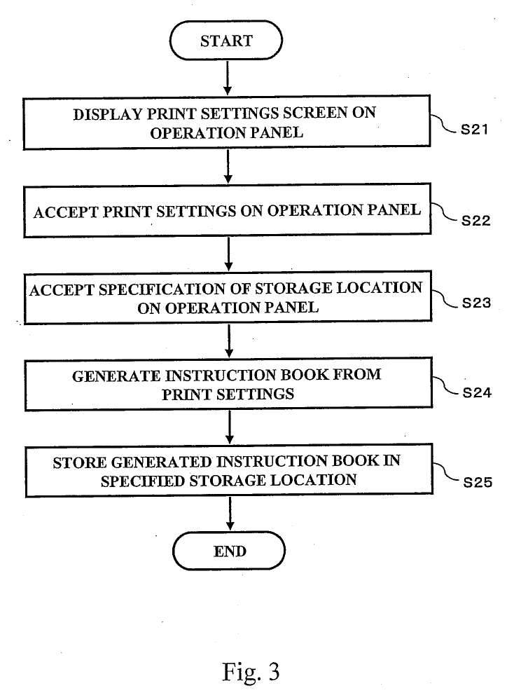

FIG. 3 is a flowchart showing the procedure for instruction book creation processing. This instruction book creation processing is executed, for example, when the “Create Instruction Book” button is pressed on the screen of the operation panel 10.

As shown in FIG. 3, the instruction book creation unit 34 displays the print settings screen on the operation panel 10 to accept the print settings (S21).

The user performs operation on the print settings screen to specify the print settings. This operation method is the same as that for the copy operation. The instruction book creation unit 34 accepts the print settings from the user via the print settings screen (S22).

The user also performs operation on the print settings screen to specify the instruction book storage location. The instruction book creation unit 34 accepts the specification of the storage location from the user via the print settings screen (S23).

When the “OK” button is pressed on the print settings screen, the instruction book creation unit 34 generates an instruction book in the XML format in accordance with the print settings specified in step S22 (S24). After that, the instruction book creation unit 34 stores the generated instruction book in the storage location specified in step S23 (S25). For example, when the memory card is specified as the storage location, the instruction book creation unit 34 stores the instruction book into the memory card 42 inserted in the memory card slot. The instruction book stored on the memory card 42 in this way is available for use on the printer 1 and other printers.

(Instruction Book Editing Processing)

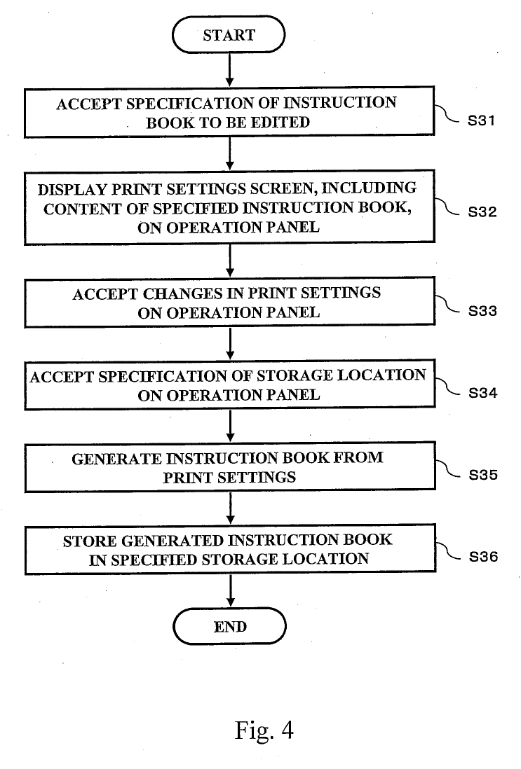

FIG. 4 is a flowchart showing the procedure for instruction book editing processing. This instruction book editing processing is executed, for example, when the “Edit Instruction Book” button is pressed on the screen of the operation panel 10.

As shown in FIG. 4, the instruction book editing unit 35 accepts the specification of the instruction book to be edited from the user via the operation panel 10 (S31). In this case, the user can select an instruction book file stored in one of the storage device 41 of the printer, the memory card 42, and the storage device 43 on the network. The below description is based on the assumption that the user stores the instruction book on the memory card 42 in advance, inserts the memory card 42 into the memory cardslot (not shown) of the printer 1, and specifies the instruction book stored on that memory card.

When the specification of the instruction book is accepted, the instruction book editing unit 35 reads the specified instruction book from the memory card 42 and displays the print settings screen, which includes the content of the instruction book, on the operation panel 10 (S32).

The user changes the print settings on the print settings screen. This operation method is the same as that of the copy operation. The instruction book editing unit 35 accepts the changes in the print settings from the user via the print settings screen (S33).

The user also specifies, on the print settings screen, the location where the edited instruction book is to be stored. The instruction book editing unit 35 accepts the specification of the storage location from the user via the print settings screen (S34).

When the “OK” button is pressed on the print settings screen, the instruction book editing unit 35 generates the edited instruction book in accordance with the print settings specified in step S33 (S35). After that, the instruction book editing unit 35 stores the generated instruction book in the storage location specified in step S34 (S36). For example, when the memory card is specified as the storage location, the instruction book editing unit 35 stores the instruction book into the memory card 42 inserted in the memory card slot. The edited instruction book stored on the memory card 42 in this way is available for use on the printer 1 and other printers.

The instruction book specification unit 31, the document specification unit 32, the instruction book creation unit 34, and the instruction book editing unit 35 can also accept the user operation via a user interface other than the operation panel 10; for example, via a client device connected to the printer 1. For example, the instruction book creation unit 34 and the instruction book editing unit 35 can cause a PC 2 on the network to display the print settings screen via the web and, via this print settings screen, to accept the creation operation or the editing operation. An instruction book created or edited on the web screen in this way is also stored in the storage device 41 of the printer, the memory card 42, or the storage device 43 on the network. The instruction book specification unit 31 and the document specification unit 32 can also accept the specification of an instruction book and a document from utility software running on the PC 2. In this case, the instruction book specification unit 31 may accept from the PC 2 an instruction book file or the address of the instruction book file. Similarly, the document specification unit 32 may accept from the PC 2 a document file or the address of the document file.

The instruction book used for the print operation, which is described above, may also be used for a copy operation. That is, when the specification of an instruction book and the specification of a copy operation are accepted from the user, the printer 1 reads the image of a document that is set on the printer 1 to thereby generate the image data and prints the image data in accordance with the print settings described in the specified instruction book.

The printer may also be configured so that, on the operation panel of the printer, the print settings can be specified within the scope of the print settings acceptable by the printer. The operation method of the operation panel for creating an instruction book may be the same as the print setting method for producing a copy.

The printer may also control the setting screen of a client device so that, on that setting screen, the print settings can be specified within the scope of the print settings acceptable by the printer. The operation method of the setting screen of the client device may be the same as the print setting method for producing a copy on the printer.

The description format of the instruction book may be standardized among multiple device types so as to allow multiple device types to use the same instruction book.

The printer may also be configured so that, on the operation panel of the printer, the print settings can be changed within the scope of the print settings acceptable by the printer. The operation method of the operation panel for editing an instruction book may be the same as the print setting method for producing a copy.

The printer may also control the setting screen of a client device so that, on that setting screen, the print settings can be changed within the scope of the print settings acceptable by the printer. The operation method of the setting screen of the client device may be the same as the print setting method for producing a copy on the printer.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

For example, it is also possible to create or edit an instruction book by means of an editor running on a PC. An instruction book created or edited on the PC can also be stored in the storage device 41 of the printer, the memory card 42, or the storage device 43 on the network.

What is claimed is:

1. A printer comprising:
an instruction book specification unit that accepts a specification of an instruction book in which print instructions are described;
a document specification unit that accepts a specification of a document to be printed; and
a print processing unit that prints the specified document in accordance with the print instructions described in the specified instruction book.

2. The printer according to claim 1, further comprising:
an instruction book creation unit that accepts a user operation via an operation panel of the printer, creates the instruction book in accordance with the user operation, and stores the created instruction book in a storage device.

3. The printer according to claim 1, further comprising:
an instruction book creation unit that accepts a user operation via a client device connected to the printer, creates the instruction book in accordance with the user operation, and stores the created instruction book in a storage device.

4. The printer according to claim 2, wherein
the instruction book creation unit stores the instruction book in a portable storage device or a storage device on a network.

5. The printer according to claim 3, wherein
the instruction book creation unit stores the instruction book in a portable storage device or a storage device on a network.

6. The printer according to claim 1, further comprising:
an instruction book editing unit that accepts a user operation via an operation panel of the printer and edits an instruction book, prepared in advance, in accordance with the user operation.

7. The printer according to claim 1, further comprising:
an instruction book editing unit that accepts a user operation via a client device connected to the printer and edits an instruction book, prepared in advance, in accordance with the user operation.

8. The printer according to claim 1, wherein
the instruction book specification unit can accept the specification of the instruction book created by some other device and stored in a storage device.

9. The printer according to claim 1, wherein
when the specification of the instruction book and a copy instruction are accepted, the printer reads an image of a document that is set on the printer, generates image data, and prints the generated image data in accordance with the print instructions described in the specified instruction book.

10. A method of printing a document, comprising
accepting a specification of an instruction book in which print instructions are described;
accepting a specification of a document to be printed; and
printing the specified document in accordance with the print instructions described in the specified instruction book.

11. A computer readable medium storing a program causing a computer to execute a process for printing a document, the process comprising:
accepting a specification of an instruction book in which print instructions are described;
accepting a specification of a document to be printed; and
printing the specified document in accordance with the print instructions described in the specified instruction book.

12. A computer data signal embodied in a carrier wave for enabling a computer to perform a process for printing a document, the process comprising:
accepting a specification of an instruction book in which print instructions are described;
accepting a specification of a document to be printed; and
printing the specified document in accordance with the print instructions described in the specified instruction book.
